(19) United States
(12) Patent Application Publication
(10) Pub. No.: US 2026/0341051 A1
(43) Pub. Date: Oct. 29, 2026

(54) STRUCTURED ILLUMINATION MICROSCOPY BASED ON PRINCIPAL COMPONENT ANALYSIS

(71) Applicant: Nanjing University of Science and Technology, Nanjing, Jiangsu (CN)

(72) Inventors: Chao ZUO, Nanjing (CN); Qian CHEN, Nanjing (CN); Jiaming QIAN, Nanjing (CN); Yongtao LIU, Nanjing (CN); Hongjun WU, Nanjing (CN); Jiasong SUN, Nanjing (CN); Shijie FENG, Nanjing (CN)

(73) Assignee: Nanjing University of Science and Technology, Nanjing, Jiangsu (CN)

(21) Appl. No.: 19/114,593

(22) PCT Filed: May 5, 2023
(86) PCT No.: PCT/CN2023/092145

§ 371 Date: Mar. 24, 2025

(30) Foreign Application Priority Data
Oct. 21, 2022 (CN) 202211295359.7

(51) Int. Cl. G06V 20/69; G01N 21/64; G06V 10/60; G06V 10/77

(52) U.S. Cl. CPC G06V 20/695; G01N 21/6458; G06V 10/60; G06V 10/77

(57) ABSTRACT

The present invention discloses a structured illumination microscopy based on Principal Component Analysis (PCA). The method utilizes the “dimensionality reduction” tool of PCA to eliminate noisy and interfering components unrelated to the illumination phase in actual imaging, in order to extract the “first principal component” dominated by illumination parameters. This fundamentally eliminates the interfering items affecting the accurate estimation of illumination parameters, thereby precisely identifying wave vectors and initial phases with sub-pixel accuracy in a simple and efficient manner. Moreover, the invention employs a two-window frequency domain mask operator to further suppress interfering noise, while reducing the data volume involved in PCA by nearly a thousand times, greatly improving the computational efficiency, accuracy, and stability of illumination parameter estimation.

### FIELD OF TECHNOLOGY

The present invention pertains to the field of super-resolution fluorescence microscopic imaging technology, specifically to a structured illumination microscopy based on Principal Component Analysis (PCA-SIM), for real-time super-resolution observation of living cells.

### BACKGROUND

Investigating the dynamic changes of fine biological structures and functions at the subcellular scale is of paramount importance for understanding the mechanisms of cell fate determination, revealing the essence of life phenomena, and exploring the pathogenesis of major diseases. In recent years, super-resolution imaging techniques such as Stimulated Emission Depletion Microscopy (STED), Structured Illumination Microscopy (SIM), and Single Molecule Localization Microscopy (Photoactivated Localization Microscopy/Stochastic Optical Reconstruction Microscopy, PALM/STORM) have circumvented what seemed to be an insurmountable Abbe diffraction limit for over a century. These techniques visualize biomolecules at the nanoscale to the single molecule level, exploring the structure and dynamics of living cells with unprecedented spatiotemporal resolution, making them indispensable tools in life science research. In 2014, the Royal Swedish Academy of Sciences awarded the Nobel Prize in Chemistry to super-resolution fluorescence microscopy techniques, once again highlighting the significant position of this technology in the course of human development and its future direction [Weiss, P. S. Nobel prizes for super-resolution imaging. (2014)].

Among the many super-resolution imaging techniques, SIM utilizes structured illumination with sinusoidal intensity modulation to encode high-frequency information of the sample into the detection passband of the optical system in the spatial frequency domain, thereby achieving super-resolution optical microscopic imaging with a lateral resolution of about 100 nm, surpassing the Abbe diffraction limit [Gustafsson, M. G. Surpassing the lateral resolution limit by a factor of two using structured illumination microscopy. J. Microsc. 198, 82-87 (2000)]. Compared to PALM, STED, and others, SIM offers unique advantages such as a wide field of view, fast imaging, low photobleaching and phototoxicity, and non-specific requirements for fluorescent dyes, making it particularly suitable for long-term dynamic super-resolution imaging of living cells [Li, D. et al. Extended-resolution structured illumination imaging of endocytic and cytoskeletal dynamics. Science 349, (2015)]. Despite its many advantages, SIM still faces some technical challenges. The numerical reconstruction of high-quality super-resolution images largely depends on the accurate estimation of illumination parameters. Minor errors in these parameters can significantly affect the reconstruction results, leading to reconstruction artifacts that interfere with quantification [Müller, M., Mönkemöller, V., Hennig, S., Hübner, W. & Huser, T. Open-source image reconstruction of super-resolution structured illumination microscopy data in ImageJ. Nat. Commun. 7, 1-6 (2016)]. In addition, the “versatile” illumination parameters are extremely sensitive to the experimental environment. Unless the imaging conditions are strictly maintained stable, illumination parameters need to be extracted frame by frame from the acquired raw observation data before each frame of super-resolution image reconstruction [Huang, X. et al. Fast, long-term, super-resolution imaging with Hessian structured illumination microscopy. Nat. Biotechnol. 36, 451-459 (2018)]. At present, the most widely used iterative cross-correlation (COR)-based parameter estimation method extracts high-precision illumination parameters (wave vector, initial phase, modulation depth) through sub-pixel optimization in the form of phase gradients in real space [Gustafsson, M. G. L. et al. Three-Dimensional Resolution Doubling in Wide-Field Fluorescence Microscopy by Structured Illumination. Biophys. J. 94, 4957-4970 (2008)]. However, the performance of COR is affected by the low signal-to-noise ratio caused by the stringent imaging conditions required to maintain long-term imaging of living cells with low photobleaching and phototoxicity. Moreover, the complex and time-consuming iterative optimization process greatly reduces the efficiency of SIM image reconstruction, posing a serious challenge to fast, real-time, long-term, and artifact-free dynamic super-resolution imaging of living cells.

### OBJECTIVE OF THE INVENTION

The present invention is to provide a structured illumination microscopy imaging method based on Principal Component Analysis (PCA), offering a rapid, real-time, flexible, convenient, and low phototoxicity observation technique for studying the nanoscale subcellular structural characteristics, dynamic states, interactions, and protein functionalities within living cells.

The technical solution to achieve the objective of the present invention is a structured illumination microscopy based on Principal Component Analysis, with specific steps as follows:
Step 1: capture the original illumination images of the sample required for super-resolution structured illumination;
Step 2: separate the three spectral information components of the sample;
Step 3: utilize a two-window frequency domain mask operator to extract the central energy of the first-order spectrum;
Step 4: acquire the illumination vector factor;
Step 5: isolate the principal components of the illumination vector factor;
Step 6: precisely estimate the illumination parameters from the principal components of the illumination vector factor;
Step 7: conduct precise spectral separation and super-resolution image reconstruction.

Preferably, the specific method for acquiring the original illumination images of the sample required for super-resolution structured illumination is as follows:
images of the sample under three different illumination directions with three-step phase-shifted sinusoidal illumination are captured through the structured illumination imaging system.

Preferably, the specific three-step phase-shifted sinusoidal illumination images in any given direction are as follows:

Dₙ(r)={S(r)[1+m cos(2πkₑₓr+(n−1)φ+φ₀)]}⊗P(r)

where D is the illumination image that is captured, the subscript n is the sequence of the images within the three-step phase-shifted series with n taking the values of 1, 2 or 3 respectively; r is the spatial coordinates within the image, ⊗ is the operation of convolution, S is the sample information, P is the point spread function of the imaging system, kₑₓ, φ₀ and m represent the wave vector, initial phase, and modulation depth of the illumination parameters, and φ is the phase shift increment.

Preferably, the three spectral information components of the sample include the 0th order and ±1st order spectral information; the specific method for separating the three spectral information components of the sample is as follows:

Step 2.1: perform a Fourier transform on the illumination image obtained in Step 1; the transformed spectral image is represented as:

$${\tilde{D}}_{n} ( k ) = \frac{m}{2} O ( k ) {\tilde{S}}_{1} ( k - {k}_{ex} ) {e}^{j [ \frac{2 π ( n - 1 )}{3} + {φ}_{0} ]} + O ( k ) {\tilde{S}}_{0} ( k ) + \frac{m}{2} O ( k ) {\tilde{S}}_{- 1} ( k + {k}_{ex} ) {e}^{- j [ \frac{2 π ( n - 1 )}{3} + {φ}_{0} ]}$$

where the superscript ~ is the Fourier transform of the original object, k is the frequency coordinates, the subscripts 0 and ±1 is the orders of the separated spectral components of the sample, \tilde{D} is the spectrum of the illumination image \tilde{D}, \tilde{S}₀, \tilde{S}₁ and \tilde{S}₋₁ is the 0^{th}-order spectrum, +1^{st}-order spectrum, and −1^{st}-order spectrum of the sample S without the optical transfer function and illumination parameter components, respectively; O is the optical transfer function of the system, j is the imaginary unit, e is the base of the natural logarithm, and kₑₓ and φ₀ are the wave vector and initial phase of the illumination parameters, respectively.

Step 2.2: perform a linear combination on the spectral image obtained from Step 2.1 to preliminarily separate the 0^{th}-order and ±1^{st}-order spectral information of the sample:

$$[ \begin{matrix}O ( k ) {\tilde{S}}_{0} ( k ) \\ m O ( k ) {\tilde{S}}_{- 1} ( k + {k}_{e x} ) {e}^{- j {φ}_{0}} \\ m O ( k ) {\tilde{S}}_{1} ( k - {k}_{e x} ) {e}^{j {φ}_{0}}\end{matrix} ] = {[ \begin{matrix}1 & \frac{1}{2} {e}^{- 0 j} & \frac{1}{2} {e}^{0 j} \\ 1 & \frac{1}{2} {e}^{- j \frac{2 π}{3}} & \frac{1}{2} {e}^{j \frac{2 π}{3}} \\ 1 & \frac{1}{2} {e}^{- j \frac{4 π}{3}} & \frac{1}{2} {e}^{j \frac{4 π}{3}}\end{matrix} ]}^{- 1} [ \begin{matrix}{\tilde{D}}_{1} ( k ) \\ {\tilde{D}}_{2} ( k ) \\ {\tilde{D}}_{3} ( k )\end{matrix} ]$$

Let C₀=O(k)\tilde{S}₀(k), C₁=mO(k)\tilde{S}₁(k−kₑₓ)e^{jφ}^{₀}, C₋₁=mO(k)\tilde{S}₋₁(k+kₑₓ)e^{-jφ}^{₀} represent the preliminarily separated 0^{th}-order and ±1^{st}-order spectral information of the sample, respectively.

Preferably, Step 3 involves extracting the central energy of the 1^{st}-order spectrum using a two-window frequency domain mask operator, specifically as follows:

Step 3.1: utilize a wave vector at an integer pixel to shift the sample's +1^{st}-order spectrum to the image center; the shifted +1^{st}-order spectral information of the sample is represented as:

C₁=mO(k+kᵢₙₜ)\tilde{S}₁(k−k_{sub})e^{jφ}^{₀}

where kᵢₙₜ is the wave vector for the integer pixel, k_{sub} is the wave vector for the sub-pixel.

Step 3.2: utilize a two-window frequency domain mask operator to extract the central spectral signal of the +1^{st}-order spectrum after it has been shifted by an integer pixel. The extracted central energy of the +1^{st}-order spectrum is represented as:

$${C}_{1} = \{ \begin{matrix}mO ( k + {k}_{int} ) {\tilde{S}}_{1} ( k - {k}_{sub} ) {e}^{j {φ}_{0}} & {k}_{x , min} \leq {k}_{x} \leq {k}_{x , max} \text{?} {k}_{y , min} \leq {k}_{y} \leq {k}_{y , max} \\ 0 & \begin{matrix}\begin{matrix}{k}_{x , min} - R \leq {k}_{x} < {k}_{x , min} \text{?} \\ {k}_{y , min} - R \leq {k}_{y} < {k}_{y , min}\end{matrix} \\ \begin{matrix}{k}_{x , max} \leq {k}_{x} < {k}_{x , max} + R \text{?} \\ {k}_{y , max} \leq {k}_{y} < {k}_{y , max} + R\end{matrix}\end{matrix} \\ NaN & \begin{matrix}{k}_{x} < {k}_{x , min} - R \text{?} {k}_{y} < {k}_{y , min} - R \\ {k}_{x} > {k}_{x , max} + R \text{?} {k}_{y} > {k}_{y , max} + R\end{matrix}\end{matrix}$$

where NaN is an invalid point, k_{x,min} is the left or lower boundary of the signal window in the horizontal x-direction, while k_{y,min} is the left or lower boundary of the signal window in the vertical y-direction, k_{x,max} is the right or upper boundary of the signal window in the horizontal x-direction, and k_{y,max} indicates the right or upper boundary of the signal window in the vertical y-direction, R is the size of the blank window within the two-window frequency domain mask operator for both horizontal and vertical directions, kₓ and k_{y} is the frequency coordinates along the horizontal x-direction and the vertical y-direction, respectively.

Preferably, the specific method for obtaining the illumination vector factor in Step 4 is as follows:
perform an inverse Fourier transform on the +1^{st}-order central spectral information of the sample to obtain its exponential term:

exp j{angle[F⁻¹(C₁)]}

where exp the exponential function with base e, angle is the function that returns the phase, F⁻¹ is the operation of inverse Fourier transformation.

Preferably, the specific method for extracting the principal components of the illumination vector factor in Step 5 is as follows:

Step 5.1: perform a singular value decomposition on the illumination vector factor, and the decomposed illumination vector factor is represented as:

exp j{angle[F⁻¹(C₁)]}=UΛV^{T}

where U and V is the left and right singular matrices of the illumination vector factor, respectively; the superscript T is the transpose of a matrix, A is the singular values of the illumination vector factor;

Step 5.2: extract the principal components of the illumination vector factor, and the extracted principal components are represented as:

U(Λ·M₁)V^{T}≈e^{j(k}^{_{sub}}^{r+φ}^{₀}⁾

where

$${M}_{1} = {[ \begin{matrix}1 & … & 0 \\ ⋮ & ⋱ & ⋮ \\ 0 & … & 0\end{matrix} ]}_{( {k}_{y , max} - {k}_{y , min} + 2 R + 1 ) \times ( {k}_{x , max} - {k}_{x , min} + 2 R + 1 )} ,$$

is a matrix where the element in the first row and first column is 1 and all other elements are 0, k_{x,min} is the left or lower boundary of the signal window in the horizontal x-direction, k_{y,min} is the left or lower boundary of the signal window in the vertical y-direction, k_{x,max} is the right or upper boundary of the signal window in the horizontal x-direction, and k_{y,max} indicates the right or upper boundary of the signal window in the vertical y-direction, R is the size of the blank window within the two-window frequency domain mask operator for both horizontal and vertical directions.

Preferably, the specific steps for estimating the illumination parameters from the principal components of the illumination vector factor in Step 6 are as follows:

Step 6.1: perform a phase unwrapping on the elements of the first row of the left singular matrix U, and conduct a linear fit using the least squares method; the slope obtained from the fit represents the horizontal component of the residual sub-pixel wave vector k_{sub}; perform a phase unwrapping on the elements of the first column of the right singular matrix V, and conduct a linear fit using the least squares method; the slope obtained from the fit represents the vertical component of the residual sub-pixel wave vector k_{sub}.

Step 6.2: obtain the initial phase φ₀ by taking the phase of the principal component of the illumination vector factor U(Λ·M₁)V^{T} at frequency 0;

Step 6.3: utilize the sub-pixel wave vector k_{sub} obtained in Step 6.1 to perform a sub-pixel shift on the sample's +1^{st}-order spectrum. Acquire the modulation depth m through a complex linear regression between the deconvolved +1^{st}-order spectrum and the 0^{th}-order spectrum.

Preferably, utilizing the illumination parameters obtained in Step 6, the preliminarily separated 0^{th}-order and ±1^{st}-order spectral information of the sample from Step 2 is further separated and recombined; the same operation is performed for the other two illumination directions; thereafter, a real-time super-resolution image is reconstructed through Wiener deconvolution, specifically as follows:

$$S = {F}^{- 1} \frac{{\sum }_{d , i} O ( k + i {k}_{d , ex} ) {\tilde{S}}_{d , i} ( k ) {O}^{*} ( k + i {k}_{d , ex} )}{{\sum }_{d , i} {\vert O ( k + {ik}_{d , ex} ) \vert}^{2} + {w}^{2}}$$

where the subscript i is the order of the spectrum with i taking the values of 0 or +1 or −1, subscript d is the illumination component number, k_{d,ex} is the wave vector of the d-th illumination direction, \tilde{S}_{d,i} is the i-th order spectral component of the d-th illumination direction without the components of the optical transfer function and illumination parameters, w is the Wiener constant.

Compared to existing technology, the significant advantages of the present invention are as follows: For the first time, the invention achieves rapid adaptive and precise compensation for illumination parameters in complex, low signal-to-noise ratio experimental environments with external interference, and real-time, high-quality dynamic super-resolution imaging of the fine structures of living cells. It provides a fast, real-time, flexible, convenient, and low phototoxicity observation method for studying the nanoscale subcellular structural characteristics, motion states, interactions, and protein functions within living cells. It is expected to facilitate the discovery of new biological phenomena and open up new possibilities for solving problems in cell biology, cancer research, developmental biology, and neuroscience, holding substantial significance for related fields of life sciences.

Further detailed descriptions of the present invention are provided in conjunction with the accompanying drawings.

### FIGURE DESCRIPTIONS

FIG. 1 illustrates the flowchart of the present invention.

FIG. 2 presents the experimental results of HeLa cells under different signal-to-noise ratios using the present invention and traditional methods. The cell nuclei and α-actinin are labeled by DAPI and FITC, respectively. a Wide-field image and super-resolution image obtained through the present invention. The original images are acquired using a 60×1.42NA objective lens. The α-actinin and nuclei of HeLa cells are excited by 488 nm and 405 nm lasers, respectively. b-d Wide-field images and super-resolution images obtained by traditional methods and the present invention within the boxed area of Figure a at different signal-to-noise ratios. e Wide-field images at different signal-to-noise ratios. f The structural similarity index measure (SSIM) of the super-resolution results obtained by traditional methods and the present invention at different signal-to-noise ratios, relative to the results in Figure b. This experiment was independently repeated 30 times.

FIG. 3 shows the real-time super-resolution reconstruction results of mitochondria in COS-7 cells at different time points using the present invention. The mitochondria are labeled by MitoTracker™ Green FM. a, d Wide-field images and super-resolution images obtained by the present invention. The original images are acquired using a 60×1.42NA objective lens. b, c Super-resolution images of the area within the blue square box in Figure a at different time points. e, f Super-resolution images of the areas within the blue and white square boxes in Figure d at different time points.

### SPECIFIC EMBODIMENT

A structured illumination microscopy based on Principal Component Analysis (PCA), utilizes the “dimensionality reduction” tool of PCA to eliminate noisy and interfering components unrelated to the illumination phase in actual imaging, thereby extracting the “first principal component” dominated by illumination parameters. This fundamentally eliminates the interference items affecting the precise estimation of illumination parameters, thus accurately identifying wave vectors and initial phases with sub-pixel accuracy in a simple and efficient manner. Additionally, a two-window frequency domain mask operator is employed to further suppress interfering noise, while reducing the data volume involved in PCA by nearly an order of magnitude, greatly improving the computational efficiency, accuracy, and stability of the estimation of illumination parameters. The flowchart of the method of the invention is shown in FIG. 1, with specific steps as follows:

Step 1: The sample is imaged using a structured illumination microscopy (SIM) system to collect three-step phase-shifted sinusoidal illumination images in three different illumination directions, wherein the illumination image in a particular direction is represented as:

Dₙ(r)={S(r)[1+m cos(2πkₑₓr+(n−1)φ+φ₀)]}⊗P(r) (1)

where D is the illumination image that is captured, the subscript n is the sequence of the images within the three-step phase-shifted series with n taking the values of 1, 2 or 3 respectively; r is the spatial coordinates within the image, ⊗ is the operation of convolution, S is the sample information, P is the point spread function of the imaging system, kₑₓ, φ₀ and m represent the wave vector, initial phase, and modulation depth of the illumination parameters, and φ=2π/3 is the phase shift increment.

Step 2: Preliminary separation of the sample's 0th-order and ±1st-order spectral information from the illumination images obtained in Step 1. The specific procedure is as follows:

Step 2.1: Perform a Fourier transform on the illumination image obtained in Step 1. The transformed spectral image is represented as:

$${\tilde{D}}_{n} ( k ) = \frac{m}{2} O ( k ) {\tilde{S}}_{1} ( k - {k}_{e x} ) {e}^{j [ \frac{2 π ( n - 1 )}{3} {φ}_{0} ]} + O ( k ) {\tilde{S}}_{0} ( k ) + \frac{m}{2} O ( k ) {\tilde{S}}_{- 1} ( k + {k}_{e x} ) {e}^{- j [ \frac{2 π ( n - 1 )}{3} {φ}_{0} ]} \qquad ( 2 )$$

where the superscript ~ is the Fourier transform of the original object, k is the frequency coordinates, the subscripts 0 and ±1 is the orders of the separated spectral components of the sample, \tilde{D} is the spectrum of the illumination image D, \tilde{S}₀, \tilde{S}₁ and \tilde{S}₋₁ is the 0^{th}-order spectrum, +1^{st}-order spectrum, and −1^{st}-order spectrum of the sample S without the optical transfer function and illumination parameter components, respectively; O is the optical transfer function of the system, j is the imaginary unit, e is the base of the natural logarithm, and kₑₓ and φ₀ are the wave vector and initial phase of the illumination parameters, respectively.

Step 2.2: Perform a linear combination on the spectral image obtained from Step 2.1 to preliminarily separate the 0^{th}-order and ±1^{st}-order spectral information of the sample:

$$[ \begin{matrix}O ( k ) {\tilde{S}}_{0} ( k ) \\ m O ( k ) {\tilde{S}}_{- 1} ( k + {k}_{e x} ) {e}^{- j {φ}_{0}} \\ m O ( k ) {\tilde{S}}_{1} ( k - {k}_{e x} ) {e}^{j {φ}_{0}}\end{matrix} ] = {[ \begin{matrix}1 & \frac{1}{2} {e}^{- 0 j} & \frac{1}{2} {e}^{0 j} \\ 1 & \frac{1}{2} {e}^{- j \frac{2 π}{3}} & \frac{1}{2} {e}^{j \frac{2 π}{3}} \\ 1 & \frac{1}{2} {e}^{- j \frac{4 π}{3}} & \frac{1}{2} {e}^{j \frac{4 π}{3}}\end{matrix} ]}^{- 1} [ \begin{matrix}{\tilde{D}}_{1} ( k ) \\ {\tilde{D}}_{2} ( k ) \\ {\tilde{D}}_{3} ( k )\end{matrix} ] \qquad ( 3 )$$

Rewrite the three elements on the left side of the aforementioned equation as C₀=O(k)\tilde{S}₀(k), C₁=mO(k)\tilde{S}₁(k−kₑₓ)e^{jφ}^{₀}, C₋₁=mO(k)\tilde{S}₋₁(k+kₑₓ)e^{-jφ}^{₀} represent the preliminarily separated 0^{th}-order and ±1^{st}-order spectral information of the sample, respectively.

Step 3: Utilize a two-window frequency domain mask operator to extract the central spectral information of the sample's ±1^{st}-order spectrum, specifically as follows:

Step 3.1: Employ an integer pixel wave vector to shift the +1^{st}-order spectrum of the sample, obtained in Step 2, to the center of the image. The shifted +1^{st}-order spectral information of the sample can be represented as:

C₁=mO(k+kᵢₙₜ)\tilde{S}₁(k−k_{sub})e^{jφ}^{₀} (4)

where kᵢₙₜ is the wave vector for the integer pixel, k_{sub} is the wave vector for the sub-pixel.

Step 3.2: Employ a two-window frequency domain mask operator to extract the central spectral signal of the +1^{st}-order spectrum after it has been shifted by an integer number of pixels. The processed +1^{st}-order spectral information of the sample can be represented as:

$${C}_{1} = \{ \begin{matrix}mO ( k + {k}_{int} ) {\tilde{S}}_{1} ( k - {k}_{sub} ) {e}^{j {φ}_{0}} & \begin{matrix}{k}_{x , min} \leq {k}_{x} \leq {k}_{x , max} \text{?} \\ {k}_{y , min} \leq {k}_{y} \leq {k}_{y , max}\end{matrix} \\ 0 & \begin{matrix}\begin{matrix}{k}_{x , min} - R \leq {k}_{x} < {k}_{x , min} \text{?} \\ {k}_{y , min} - R \leq {k}_{y} < {k}_{y , min}\end{matrix} \\ \begin{matrix}{k}_{x , max} \leq {k}_{x} < {k}_{x , max} + R \text{?} \\ {k}_{y , max} \leq {k}_{y} < {k}_{y , max} + R\end{matrix}\end{matrix} \\ NaN & \begin{matrix}{k}_{x} < {k}_{x , min} - R \text{?} {k}_{y} < {k}_{y , min} - R \\ {k}_{x} > {k}_{x , max} + R \text{?} {k}_{y} > {k}_{y , max} + R\end{matrix}\end{matrix} \qquad ( 5 )$$

where NaN is an invalid point, k_{x,min} and k_{y,min} represent the left or lower boundary of the signal window in the two-window frequency domain mask operator for the horizontal x and vertical y directions, respectively, k_{x,max} and k_{y,max} are the right or upper boundary of the signal window in the two-window frequency domain mask operator for the horizontal x and vertical y directions, respectively, R is the size of the blank window within the two-window frequency domain mask operator for both horizontal and vertical directions, kₓ and k_{y} represent the frequency coordinates along the horizontal x-direction and the vertical y-direction, respectively. The dimensions of the signal and blank windows, namely the values of k_{x,min}, k_{y,min}, k_{x,max}, k_{y,max} and R, are obtained by maximizing the value that satisfies equation N²P/(k_{x(y),max}−k_{x(y),min}+2R+1)² (where N is the size of the complete spectral image, P is the ratio between the spectral amplitude within the signal window and the total spectral amplitude). Step 3 effectively removes interference signals unrelated to the illumination parameters and reduces the amount of data to be processed in subsequent steps by nearly an order of magnitude, thereby ensuring efficient and high-precision estimation of illumination parameters.

Step 4: Obtain the illumination vector factor from the central spectral information of the sample's +1st-order spectrum obtained in Step 3, specifically as follows:

Perform an inverse Fourier transform on the central spectral information of the sample's +1^{st}-order spectrum obtained in Step 3, and acquire its exponential term:

exp j{angle[F⁻¹(C₁)]} (6)

where exp the exponential function with base e, angle is the function that returns the phase, F⁻¹ is the operation of inverse Fourier transformation. Equation (6) represents the obtained illumination vector factor.

Step 5: Extract the principal components of the illumination vector factor obtained in Step 4, specifically as follows:

Step 5.1: Perform a singular value decomposition on the illumination vector factor obtained in Step 4, and the decomposed illumination vector factor can be represented as:

exp j{angle[F⁻¹(C₁)]}=UΛV^{T} (7)

where U and V is the left and right singular matrices of the illumination vector factor, respectively; the superscript T is the transpose of a matrix, Λ is the singular values of the illumination vector factor.

Step 5.2: Extract the principal components of the illumination vector factor, where the extracted principal components can be represented as:

U(Λ·M₁)V^{T}≈e^{j(k}^{_{sub}}^{r+φ}^{₀}⁾ (8)

where

$${M}_{1} = {[ \begin{matrix}1 & … & 0 \\ ⋮ & ⋱ & ⋮ \\ 0 & … & 0\end{matrix} ]}_{( {k}_{y , max} - {k}_{y , min} + 2 R + 1 ) \times ( {k}_{x , max} - {k}_{x , min} + 2 R + 1 )} ,$$

is a matrix where the element in the first row and first column is 1 and all other elements are 0. The actual imaging components that are unrelated to the illumination vector and are noisy and interfering are eliminated in Step 5, fundamentally removing the interference items that affect the precise estimation of the illumination parameters, thereby endowing the parameter estimation with strong noise resistance.

Step 6: Accurately estimate the illumination parameters based on the principal components of the illumination vector factor obtained in Step 5, specifically as follows:

Step 6.1: Perform a phase unwrapping on the elements of the first row of the left singular matrix U obtained in Step 5, followed by a linear fit using the least squares method; the slope obtained from the fit represents the horizontal component of the residual sub-pixel wave vector k_{sub}. Similarly perform a phase unwrapping on the elements of the first column of the right singular matrix V, followed by a linear fit using the least squares method; the slope obtained from the fit represents the vertical component of the residual sub-pixel wave vector k_{sub}.

Step 6.2: Obtain the initial phase φ₀ by taking the phase of the principal component of the illumination vector factor U(Λ·M₁)V^{T} at frequency 0.

Step 6.3: Utilize the sub-pixel wave vector k_{sub} obtained in Step 6.1 to perform a sub-pixel shift on the sample's +1^{st}-order spectrum. Subsequently, acquire the modulation depth m through a complex linear regression between the deconvolved +1^{st}-order spectrum and the 0^{th}-order spectrum:

$$m = \vert \frac{{\sum }_{r} {mS}_{0}^{*} ( r ) {S}_{1} ( r ) {e}^{j {φ}_{0}}}{{\sum }_{r} {\vert {S}_{0} ( r ) \vert}^{2}} \vert \qquad ( 9 )$$

where the superscript * denotes the complex conjugate of the original object. The sub-pixel wave vector k_{sub}, initial phase φ₀, and modulation depth m obtained from Steps 6.1, 6.2, and 6.3 are the illumination parameters. The non-iterative nature of Step 6 endows the parameter estimation with an efficient processing speed.

Step 7: Utilize the illumination parameters obtained in Step 6 to precisely separate and recombine the preliminarily separated 0th-order and +1^{st}-order spectral information of the sample from Step 2. Perform the same operation for the other two illumination directions, and ultimately reconstruct real-time super-resolution images through Wiener deconvolution:

$$S = {F}^{- 1} \frac{{\sum }_{d , i} O ( k + i {k}_{d , ex} ) {\tilde{S}}_{d , i} ( k ) {O}^{*} ( k + i {k}_{d , ex} )}{{\sum }_{d , i} {\vert O ( k + {ik}_{d , ex} ) \vert}^{2} + {w}^{2}} \qquad ( 10 )$$

where the subscript i is the order of the spectrum with i taking the values of 0 or +1 or −1, subscript d is the illumination component number, k_{d,ex} is the wave vector of the d-th illumination direction, \tilde{S}_{d,i} is the i-th order spectral component of the d-th illumination direction without the components of the optical transfer function and illumination parameters, w is the Wiener constant (typically determined empirically).

High precision, non-iterative reconstruction, robust noise resistance, and limited computational complexity make the present invention a promising method for fast, long-term, and artifact-free super-resolution imaging of living cells. For the first time, it achieves rapid adaptive and precise compensation for illumination parameters in complex, low signal-to-noise ratio experimental environments with external interference, and real-time, high-quality dynamic super-resolution imaging of the fine structures of living cells.

### IMPLEMENTATION EXAMPLE

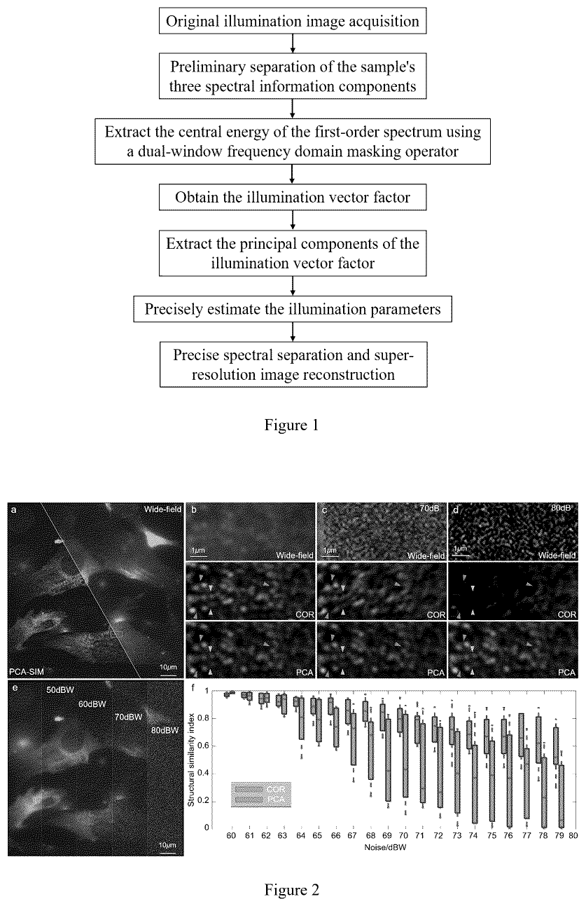

To test the feasibility and real-time performance of the present invention, the method described in this invention (structured illumination microscopy based on principal component analysis, PCA-SIM) was first used to perform super-resolution reconstruction on fixed HeLa cell samples under different signal-to-noise ratios. As can be seen from FIG. 2, as the signal-to-noise ratio decreases or as the power of the applied Gaussian noise increases (unit: dBW), noticeable structural distortions and contrast imbalances appear in the super-resolution images obtained by the traditional iterative cross-correlation parameter estimation method (cross-correlation approach, COR) (FIGS. 2a-2e). In contrast, the method described in this invention effectively suppresses these image artifacts and reconstructs high-quality super-resolution results comparable to those under regular signal-to-noise conditions. Quantitative data at different signal-to-noise ratios indicate that the invention exhibits strong robustness under noisy conditions (FIG. 2f). In terms of speed, the computational speed of the present invention is nearly 20 times faster than the traditional cross-correlation method. This implementation example demonstrates the comprehensive advantages of the invention in terms of accuracy, efficiency, and noise resistance, as well as its potential for long-term live cell imaging under weak excitation conditions.

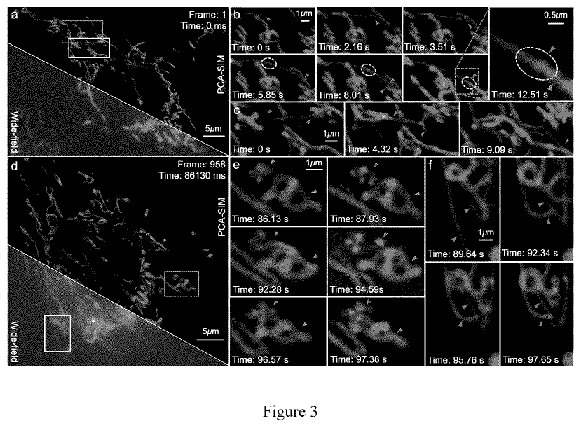

An important application of the present invention is to observe the dynamics of subcellular structures in real-time under complex or harsh operating conditions. To verify this, the invention was used to observe the mitochondrial dynamic tubulation (MDT) events of live COS-7 cells in real-time. As shown in FIGS. 3a-3b, the slender and highly dynamic MDT tubules that rapidly extend from the mitochondria fuse with other mitochondria and form their previous membrane bridges, during which some material transfer occurs (marked by the white dashed circle in FIG. 3b). Subsequently, the MDT tubules gradually thicken and stabilize, eventually forming the mitochondrial network. These experimental phenomena are of great significance for studying the formation of the mitochondrial network and the maintenance of mitochondrial functions (such as mitochondrial DNA integrity, apoptosis, etc.). This implementation example fully demonstrates the advantages of the invention in exploring the structure and dynamics of living cells.

1. A structured illumination microscopy based on principal component analysis, characterized in that the specific steps are:
Step 1: acquire the original illumination images of the sample required for super-resolution structured illumination;
Step 2: separate the three spectral information components of the sample;
Step 3: extract the central energy of the 1^{st}-order spectrum using a two-window frequency domain mask operator;
Step 4: obtain the illumination vector factor;
Step 5: extract the principal components of the illumination vector factor;
Step 6: precisely estimate the illumination parameters from the principal components of the illumination vector factor;
Step 7: perform precise spectral separation and super-resolution image reconstruction.

2. The structured illumination microscopy imaging method based on principal component analysis as claimed in claim 1, characterized in that the specific method for acquiring the original illumination images of the sample required for super-resolution structured illumination is:
images are collected through a structured illumination imaging system of the sample under three different illumination directions with three-step phase-shifted sinusoidal illumination.

3. The structured illumination microscopy imaging method based on principal component analysis as claimed in claim 2, characterized in that the three-step phase-shifted sinusoidal illumination images in any given direction are specifically as follows:
Dₙ(r)={S(r)[1+m cos(2πkₑₓr+(n−1)φ+φ₀)]}⊗P(r)
where D is the illumination image that is captured, the subscript n is the sequence of the images within the three-step phase-shifted series with n taking the values of 1, 2 or 3 respectively; r is the spatial coordinates within the image, ⊗ is the operation of convolution, S is the sample information, P is the point spread function of the imaging system, kₑₓ, φ₀ and m represent the wave vector, initial phase, and modulation depth of the illumination parameters, and φ is the phase shift increment.

4. The structured illumination microscopy based on principal component analysis as claimed in claim 1, characterized in that the three spectral information components of the sample include the 0^{th}-order and ±1^{st}-order spectral information, and the specific method for separating the three spectral information components of the sample is:
Step 2.1: perform a Fourier transform on the illumination images obtained in Step 1, and the transformed spectral images are represented as:
$${\tilde{D}}_{n} ( k ) = \frac{m}{2} O ( k ) {\tilde{S}}_{1} ( k - {k}_{e x} ) {e}^{j [ \frac{2 π ( n - 1 )}{3} {φ}_{0} ]} + O ( k ) {\tilde{S}}_{0} ( k ) + \frac{m}{2} O ( k ) {\tilde{S}}_{- 1} ( k + {k}_{e x} ) {e}^{- j [ \frac{2 π ( n - 1 )}{3} {φ}_{0} ]}$$
where the superscript ~ is the Fourier transform of the original object, k is the frequency coordinates, the subscripts 0 and ±1 is the orders of the separated spectral components of the sample, \tilde{D} is the spectrum of the illumination image D, \tilde{S}₀, \tilde{S}₁ and \tilde{S}₋₁ is the 0^{th}-order spectrum, +1^{st}-order spectrum, and −1^{st}-order spectrum of the sample S without the optical transfer function and illumination parameter components, respectively; O is the optical transfer function of the system, j is the imaginary unit, e is the base of the natural logarithm, and kₑₓ and φ₀ are the wave vector and initial phase of the illumination parameters, respectively;
Step 2.2: perform a linear combination on the spectral image obtained from Step 2.1 to preliminarily separate the 0^{th}-order and ±1^{st}-order spectral information of the sample:
$$[ \begin{matrix}O ( k ) {\tilde{S}}_{0} ( k ) \\ m O ( k ) {\tilde{S}}_{- 1} ( k + {k}_{e x} ) {e}^{- j {φ}_{0}} \\ m O ( k ) {\tilde{S}}_{1} ( k - {k}_{e x} ) {e}^{j {φ}_{0}}\end{matrix} ] = {[ \begin{matrix}1 & \frac{1}{2} {e}^{- 0 j} & \frac{1}{2} {e}^{0 j} \\ 1 & \frac{1}{2} {e}^{- j \frac{2 π}{3}} & \frac{1}{2} {e}^{j \frac{2 π}{3}} \\ 1 & \frac{1}{2} {e}^{- j \frac{4 π}{3}} & \frac{1}{2} {e}^{j \frac{4 π}{3}}\end{matrix} ]}^{- 1} [ \begin{matrix}{\tilde{D}}_{1} ( k ) \\ {\tilde{D}}_{2} ( k ) \\ {\tilde{D}}_{3} ( k )\end{matrix} ]$$
let C₀=O(k)\tilde{S}₀(k), C₁=mO(k)\tilde{S}₁(k−kₑₓ)e^{jφ}^{₀}, C₋₁=mO(k)\tilde{S}₋₁(k+kₑₓ)e^{-jφ}^{₀} represent the preliminarily separated 0^{th}-order and ±1^{st}-order spectral information of the sample, respectively.

5. The structured illumination microscopy based on principal component analysis as claimed in claim 1, characterized in that Step 3 extracts the central energy of the first-order spectrum using a two-window frequency domain mask operator, specifically as follows:
Step 3.1: utilize a wave vector at an integer pixel to shift the sample's +1^{st}-order spectrum to the image center; the shifted +1^{st}-order spectral information of the sample is represented as:
C₁=mO(k+kᵢₙₜ)\tilde{S}₁(k−k_{sub})e^{jφ}^{₀}
where kᵢₙₜ is the wave vector for the integer pixel, k_{sub} is the wave vector for the sub-pixel;
Step 3.2: utilize a two-window frequency domain mask operator to extract the central spectral signal of the +1^{st}-order spectrum after it has been shifted by an integer pixel; the extracted central energy of the +1^{st}-order spectrum is represented as:
$${C}_{1} = \{ \begin{matrix}mO ( k + {k}_{int} ) {\tilde{S}}_{1} ( k - {k}_{sub} ) {e}^{j {φ}_{0}} & {k}_{x , min} \leq {k}_{x} \leq {k}_{x , max} \text{?} {k}_{y , min} \leq {k}_{y} \leq {k}_{y , max} \\ 0 & \begin{matrix}\begin{matrix}{k}_{x , min} - R \leq {k}_{x} < {k}_{x , min} \text{?} \\ {k}_{y , min} - R \leq {k}_{y} < {k}_{y , min}\end{matrix} \\ \begin{matrix}{k}_{x , max} \leq {k}_{x} < {k}_{x , max} + R \text{?} \\ {k}_{y , max} \leq {k}_{y} < {k}_{y , max} + R\end{matrix}\end{matrix} \\ NaN & \begin{matrix}{k}_{x} < {k}_{x , min} - R \text{?} {k}_{y} < {k}_{y , min} - R \\ {k}_{x} > {k}_{x , max} + R \text{?} {k}_{y} > {k}_{y , max} + R\end{matrix}\end{matrix}$$
where NaN is an invalid point, k_{x,min} is the left or lower boundary of the signal window in the horizontal x-direction, while k_{y,min} is the left or lower boundary of the signal window in the vertical y-direction, k_{x,max} is the right or upper boundary of the signal window in the horizontal x-direction, and k_{y,max} indicates the right or upper boundary of the signal window in the vertical y-direction, R is the size of the blank window within the two-window frequency domain mask operator for both horizontal and vertical directions, kₓ and k_{y} is the frequency coordinates along the horizontal x-direction and the vertical y-direction, respectively.

6. The structured illumination microscopy based on principal component analysis as claimed in claim 1, characterized in that the specific method for obtaining the illumination vector factor in Step 4 is as follows:
perform an inverse Fourier transform on the +1^{st}-order central spectral information of the sample to obtain its exponential term:
exp j{angle[F⁻¹(C₁)]}
where exp the exponential function with base e, angle is the function that returns the phase, [symbol] ⁻¹ is the operation of inverse Fourier transformation.

7. The structured illumination microscopy based on principal component analysis as claimed in claim 1, characterized in that the specific method for extracting the principal components of the illumination vector factor in Step 5 is as follows:
Step 5.1: perform a singular value decomposition on the illumination vector factor, and the decomposed illumination vector factor is represented as:
exp j{angle[F⁻¹(C₁)]}=UΛV^{T}
where U and V is the left and right singular matrices of the illumination vector factor, respectively; the superscript T is the transpose of a matrix, Λ is the singular values of the illumination vector factor;
Step 5.2: extract the principal components of the illumination vector factor, and the extracted principal components are represented as:
U(Λ·M₁)V^{T}≈e^{j(k}^{_{sub}}^{r+φ}^{₀}⁾
where
$${M}_{1} = {[ \begin{matrix}1 & … & 0 \\ ⋮ & ⋱ & ⋮ \\ 0 & … & 0\end{matrix} ]}_{( {k}_{y , max} - {k}_{y , min} + 2 R + 1 ) \times ( {k}_{x , max} - {k}_{x , min} + 2 R + 1 )} ,$$
is a matrix where the element in the first row and first column is 1 and all other elements are 0, k_{x,min} is the left or lower boundary of the signal window in the horizontal x-direction, k_{y,min} is the left or lower boundary of the signal window in the vertical y-direction, k_{x,max} is the right or upper boundary of the signal window in the horizontal x-direction, and k_{y,max} indicates the right or upper boundary of the signal window in the vertical y-direction, R is the size of the blank window within the two-window frequency domain mask operator for both horizontal and vertical directions.

8. The structured illumination microscopy based on principal component analysis as claimed in claim 7, characterized in that the specific steps for estimating the illumination parameters from the principal components of the illumination vector factor in Step 6 are as follows:
Step 6.1: perform a phase unwrapping on the elements of the first row of the left singular matrix U, and conduct a linear fit using the least squares method; the slope obtained from the fit represents the horizontal component of the residual sub-pixel wave vector k_{sub}; perform a phase unwrapping on the elements of the first column of the right singular matrix V, and conduct a linear fit using the least squares method; the slope obtained from the fit represents the vertical component of the residual sub-pixel wave vector k_{sub};
Step 6.2: obtain the initial phase φ₀ by taking the phase of the principal component of the illumination vector factor U(Λ·M₁)V^{T} at frequency 0;
Step 6.3: utilize the sub-pixel wave vector k_{sub} obtained in Step 6.1 to perform a sub-pixel shift on the sample's +1^{st}-order spectrum; acquire the modulation depth m through a complex linear regression between the deconvolved +1^{st}-order spectrum and the 0^{th}-order spectrum.

9. The structured illumination microscopy based on principal component analysis as claimed in claim 1, characterized in that the illumination parameters obtained in Step 6 are utilized to separate and recombine the preliminarily separated 0^{th}-order and ±1^{st}-order spectral information of the sample from Step 2, and the same operation is performed for the other two illumination directions, to reconstruct real-time super-resolution images through Wiener deconvolution, specifically as follows:
$$S = {F}^{- 1} \frac{{\sum }_{d , i} O ( k + i {k}_{d , ex} ) {\tilde{S}}_{d , i} ( k ) {O}^{*} ( k + i {k}_{d , ex} )}{{\sum }_{d , i} {\vert O ( k + {ik}_{d , ex} ) \vert}^{2} + {w}^{2}}$$
where the subscript i is the order of the spectrum with i taking the values of 0 or +1 or −1, subscript d is the illumination component number, k_{d,ex} is the wave vector of the d-th illumination direction, \tilde{S}_{d,i} is the i-th order spectral component of the d-th illumination direction without the components of the optical transfer function and illumination parameters, w is the Wiener constant.
